(19) United States
(12) Patent Application Publication
(10) Pub. No.: US 2003/0067648 A1
(43) Pub. Date: Apr. 10, 2003

(54) Optical maintenance signaling in optical data networks

(76) Inventors: Roman Antosik, Colts Neck, NJ (US); Jayanta Das, Morganville, NJ (US); Bharat Dave, Howell, NJ (US); Kuo-Ming Lee, Morganville, NJ (US); David Lowe, Howell, NJ (US); Kwang Kim, Red Bank, NJ (US); Jithamithra Sarathy, Atlantic Highlands, NJ (US); Ronald Simprini, Red Bank, NJ (US); Boris Stefanov, Gillette, NJ (US); Tan Thai, Jackson, NJ (US); Wai-Ching Yu, Holmdel, NJ (US)

Correspondence Address: KAPLAN & GILMAN , L.L.P., 900NROUTE 9 NORTH, WOODBRIDGE, NJ, 07095, US

(21) Appl. No.: 10/118,596

(22) Filed: Apr. 8, 2002

Related U.S. Application Data
(60) Provisional application No. 60/282,072, filed on Apr. 6, 2001.

(51) Int. Cl. H04J 14/02

(52) U.S. Cl. 359/124

(57) ABSTRACT

A method and apparatus are presented for implementing maintenance signaling in an optical data network, said method comprising the use of a finite set of optical symbols to distinguish between different classes of failures. The method is format and bit rate transparent, and a network element does not need to read bits to interpret a signaling message. Faults protected within the network are distinguished from faults originating outside the network, and power glitches are filtered out of incoming alarm signals originating outside the network.

### CROSS REFERENCE TO OTHER APPLICATIONS

This application claims the benefit of U.S. Provisional Patent Application Serial No. 60/282,072, filed on Apr. 6, 2001.

### TECHNICAL FIELD

This invention relates to data communications, and in particular to a bit rate and format transparent method of optical maintenance signaling.

### BACKGROUND OF THE INVENTION

Optical fiber networks are in widespread use due to their ability to support high bandwidth connections. The bandwidth of optical fibers runs into gigabits and even terabits. Optical links can thus carry hundreds of thousands of communications channels multiplexed together.

One of the fundamental requirements of nodal network elements in optical networks is the capability to signal other nodal elements as to the occurrence of faults and failures. Presently, this is achieved by converting the incoming optical signal into an electrical signal followed reading various format dependent bits. All optical networks require maintenance signaling without resorting to Optical-to-Electrical, or O-E-O, conversion of the signal.

Future optical networking systems will incorporate service signals at both 10 Gb/s, 40 Gb/s and much higher nominal bit rates, along with the associated Forward Error Corrected (FEC) line rate at each nominal bit rate. The FEC rates associated with, for example, 10 Gb/s optical signal transport include the 64/63 coding for 10 Gb/s Ethernet, the 15/14 encoding of SONET-OC192 FEC, and the strong-FEC rate of 12.25 Gb/s. As these networks tend towards optical transparency, the nodal devices in the optical network must work with any commercially desired line rate, independent of format, whatever that is or that may be. If maintenance signaling is done by using a prescribed set of bits in a prescribed location in a data packet, which then must be read by a network node, such signaling cannot be used for a format and bit rate transparent network. Thus, one of the fundamental functions these devices must provide is the capability to implement wholly optical maintenance signaling in such an environment.

What is therefore needed is an all-optical maintenance signaling system that requires neither OEO conversion nor requires the network nodes to read/decode bits to convey maintenance information throughout a data network.

### SUMMARY OF THE INVENTION

A method and apparatus are presented for implementing maintenance signaling in an optical data network, said method comprising the use of a finite set of optical symbols to distinguish between different classes of failures. The method is format and bit rate transparent, and a network element does not need to read bits to interpret a signaling message. Faults protected within the network are distinguished from faults originating outside the network, and power glitches are filtered out of incoming alarm signals originating outside the network.

### BRIEF DESCRIPTION OF DRAWINGS

FIG. 1 depicts the basic topology of an optical network;

FIG. 2 depicts a state transition diagram according to the present invention;

FIG. 3 depicts the functions of a maintenance signal according to the present invention;

FIG. 4 depicts a state transition diagram;

FIG. 5 depicts an equipped I/O port used in the present invention;

FIG. 6 depicts a block diagram of an ORM controller according to the present invention;

FIG. 7 depicts a block diagram of an OTM controller according to the present invention;

FIG. 8 illustrates shutting off output power to an ORM;

FIG. 9 depicts an exemplary state transition diagram of an OTMM-Gin OTM mode according to the present invention;

FIG. 10 depicts an exemplary state transition diagram of an ORMM-Gin OTM mode according to the present invention;

FIG. 11 depicts an exemplary state transition diagram of an OTMM-Gin OTM mode according to the present invention;

FIG. 12 depicts an exemplary state transition diagram of an OTMM-ImdP mode according to the present invention;

FIG. 13 depicts an exemplary state transition diagram of an ORMM-GoutP ORM mode according to the present invention; and

FIG. 14 depicts an exemplary state transition diagram of an OTMM-GoutP OTM mode according to the present invention.

### DETAILED DESCRIPTION OF THE PREFERRED EMBODIMENTS

Before one or more embodiments of the invention are explained in detail, it is to be understood that the invention is not limited in its application to the details of construction or the arrangements of components set forth in the following description or illustrated in the drawings (the terms “construction” and “components” being understood in the most general sense and thus referring to and including, in appropriate contexts, methods, algorithms, processes and subprocesses). The invention is capable of other embodiments and of being practiced or being carried out in various ways. Also, it is to be understood that the phraseology and terminology used herein is for the purpose of description and should not be regarded as in any way limiting.

While the present invention is presented vis-à-vis optical networks, the invention is just as applicable to any communications network or system where format free signaling is effectuated without requiring network elements (in the most general sense) to decode and read bits, rather relying on format and bit-free aspects of the signals and signal carriers themselves to convey information.

Optical networks protect customer traffic against network failures. For all-optical networks the speed of protection must be at least that of SONET ring networks: 60 mseconds for single failures (span protection) and 200 mseconds for multiple failures (ring protection). SONET rings require 50% of transmission capacity dedicated for protection. The challenge is to design an optical network protecting failures as fast as SONET but with less than the required 50% protection capacity. One possibility is to use dynamic end-to-end mesh restoration, which searches for alternate routes for the failed service lightpaths at the time of failure. This makes it much slower than the SONET restoration. Local mesh restoration is faster but gives limited choice of diverse alternate routes and thus requires more capacity for protection. To assure fast failure detection and node-to-node maintenance signaling, the present invention uses all optical maintenance signals. In an exemplary embodiment two such signals are used. The first, being called OAIS (optical alarm indication signal), is used to signal failures protected by the optical network, and the second being called OIDLE, is used to signal failures not protected by the optical network. The signaling is used in unidirectional and bi-directional end-to-end protection as well as in unidirectional and bi-directional, local mesh, region-by-region protection. The following features of optical maintenance signaling in optical networks are supported:

1. A loss of power (LOP) failure and corresponding maintenance signaling generated outside boundaries of the optical network is transparently transferred through the network;

2. An LOP failure and the corresponding maintenance signaling generated by DWDM transmission systems inside the optical network protecting the failure is suppressed by the network and is not transferred to a client terminal; and

3. An LOP failure and corresponding maintenance signaling by the DWDM transmission systems inside the boundaries of the optical network not protecting the failure is transferred (as a LOP) to a client terminal.

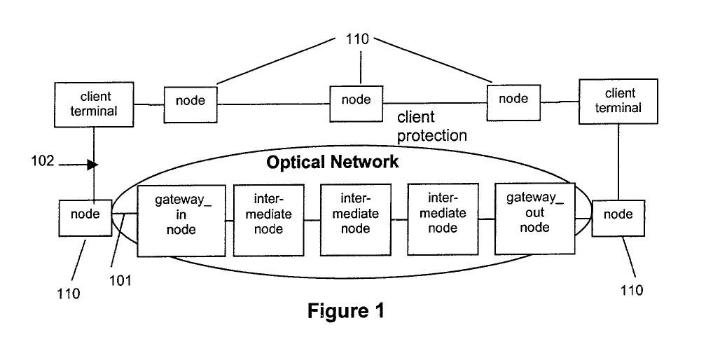

FIG. 1 shows an exemplary service lightpath 101 that originates and terminates outside the optical network. The optical network does not protect it, rather the service lightpath is end-to-end protected by external client provided protection 102. Within the optical network, each service lightpath node performs one of the following functions: gateway_in, intermediate, region-boundary, and gateway_out. In FIG. 1 a “node” 110 indicates a node outside the boundaries of the optical network. These nodes 110 are capable of generating their own maintenance signals. In addition, maintenance signals could be generated by DWDM transmission systems inside and outside the boundaries of the optical network. Client terminals can detect these maintenance signals and trigger external end-to-end client protection. For example a client terminal could be a SONET terminal capable of detecting LOP or SONET AIS to trigger SONET span or ring protection switch.

Client protection requires downstream maintenance signaling of a detected failure. From the optical network point of view it does not matter if client protection exist or not; it is simply assumed that it is and the optical network assures transparency of the maintenance signaling generated outside its own boundaries.

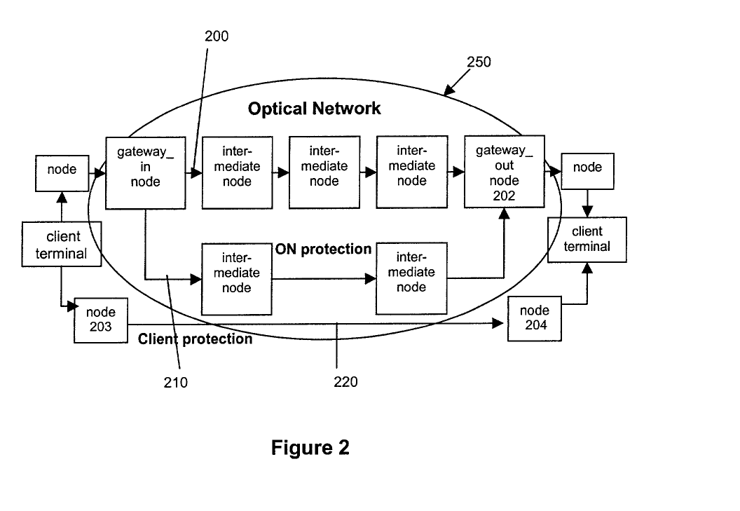

FIG. 2 shows an exemplary service lightpath 200 running between nodes 201 and 202 within the optical network (“ON”) 250 that is protected by the optical network 250 via a protection lightpath 210, also running between nodes 201 and 202. The same service lightpath is end-to-end protected by an external client protection lightpath 220, which runs between nodes 203 and 204.

It is noted that in the exemplary network of FIG. 2, end-to-end maintenance signaling spans the length of the entire service lightpath. This presents a potential problem for maintenance signalling. The lightpath length determines protection switching time performance. In large networks, with long end-to-end service lightpaths, required performance may not be met. In addition, long end-to-end protection busies too many protection resources and increases the chance of contention for shared protection bandwidth. Further, end-to-end protection requires the provisioning of long protection lightpaths, which may prove a difficult task for the routing algorithms.

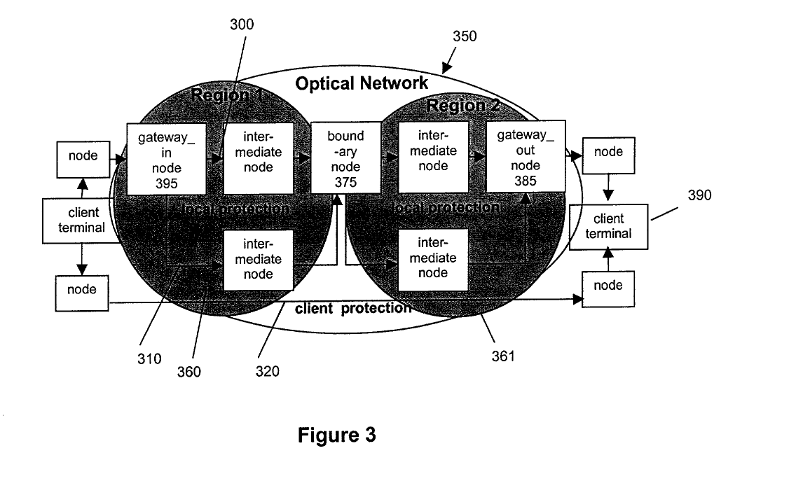

Thus, in a preferred embodiment of the invention, local mesh protection will be used, an example of which is shown in FIG. 3. FIG. 3 shows a service lightpath originated and terminated outside the boundaries of an optical network that is region-by-region protected by the optical network. Using region-by-region local mesh protection, each service lightpath 300 crosses several regions of protection 360, 361 within the optical network. Each region 360, 361 protects against the failures of one section of the service lightpath 300. A regional boundary node 275 executes protection as shown in FIG. 3, being part of each local protection lightpath adjacent to it. The OAIS signaling of a failure in one region is replaced by an OIDLE signal in the downstream regions. A regional boundary node detects an incoming OAIS signal and inserts an OIDLE signal to regions downstream from it.

OIDLE and OAIS maintenance signaling

In general unprotected service lightpaths, as well as 1+1 protected service lightpaths, require only one maintenance signal. Shared protection requires two optical maintenance signals, one to signal failures protected by the optical network (herein illustratively designated as OAIS) and another (herein illustratively designated as OIDLE) to signal failures not protected by the optical network.

In an all optical network these signals must be bit rate and format independent, and thus are not distinguishable not by reading any bits or bit fields. Rather, information is conveyed by detecting some optical property, such as the frequency of the light, or some specific polarization, or by the use of defined lapses of time between one optical symbol and another, etc. Thus these signals are referred to herein as “optical symbols.”

Failures protected by the optical network are failures of a service lightpath protected by the optical network which occur inside the boundaries of the optical network. A gateway-out node 385 detecting an OAIS signal triggers protection and suppresses failure detection by the client terminal 390 by inserting OIDLE to the client terminal 390. Failures not protected by the optical network are failures which occur outside the boundaries of the optical network or are failures of service lightpaths which occur within the network, but which are not provisioned for protection by the network. A gateway-out node 385 detecting an OIDLE signal triggers the transfer of the LOP failure or of an outside maintenance signal, if one was generated by an extra-network source, to the client terminal 390.

Indirect detection of AIS maintenance signaling

According to the method of the present invention, nodes in a transparent optical network do not directly detect general alarm indication signals (AIS) generated outside of its boundaries or signals inserted by the DWDM transmission systems. This is because with respect to a general external to the network device, the network nodes cannot be assumed to have interoperability with such device. As well, the all optical network nodes do not read bits from “foreign” devices. They detect the externally generated AIS signals temporally (i.e., by using time as a means to encode/decode information), in an indirect way (thus obviating reading bits and thereby preserving transparency) by detecting a maintenance signal that is neither OIDLE nor OAIS and which clears fixed length LOP detection. The indirect detection of an AIS will be designated by an “AIS” suffix herein. A distinction between a client signal and an AIS inserted by an optical-electronic-optical (OEO) regenerator (operating outside the optical network) is required to be made in order to be able to distinguish between power glitches—which are characterized by the detection sequence “client_signal-LOP-client_Signal”—and the externally inserted maintenance signal, characterized by the sequence “client_signal-LOP_{AIS}-AIS.”

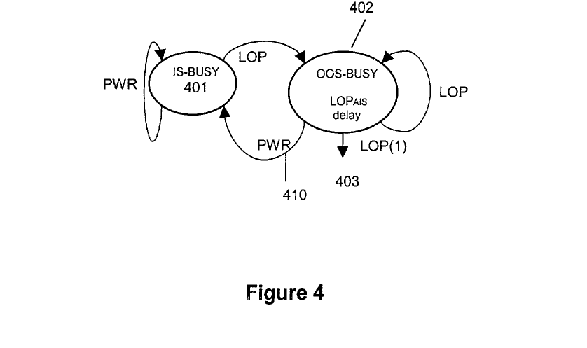

FIG. 4 shows an exemplary state transition diagram of such a power glitch filter. The filter works as follows. All states refer to those of the upstream node, as perceived by the system. State 401 is the in-service-busy state. A detected LOP (Loss of Power) shifts the state to state 402, out-of-service-busy, which starts the LOPAIs delay. If during that delay the power comes back-up, the LOP is interpreted as being part of a client-signal—the detected LOP being merely a power glitch, and the state returns to IS-BUSY 401, thus filtering out the power glitch from an AIS signal. If the power comes back up only after the LOP_{AIS} delay has timed out, the LOP is interpreted as an externally inserted AIS signal. Different OEO devices are characterized by different LOP_{AIS} delays. Thus, the failure detector can thus be provisioned for different LOP_{AIS} delays. If a particular OEO takes more than the provisioned delay to insert AIS (within some defined tolerance), the receiving node and optical network do not continue to wait for it, but assume that the detected failure is a persistent LOP failure 403 not followed by AIS. Once so categorized, the filter sends a persistent LOP signal 403, and receipt of PWR 410 will no longer send the upstream node into state 401.

Node design

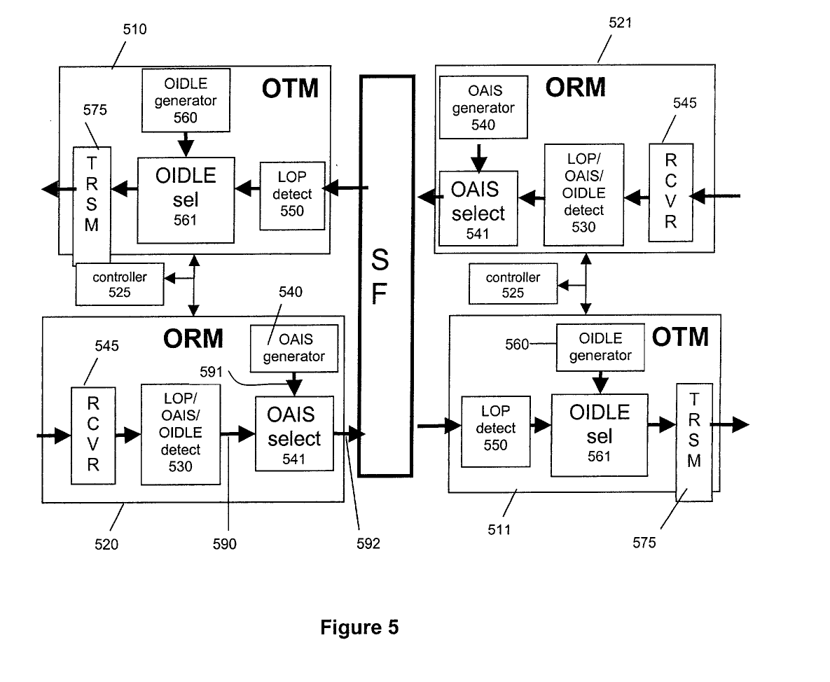

FIG. 5 shows an exemplary node design according to the present invention where (i) detection of LOP, OAIS and OIDLE and (ii) insertion of the OAIS maintenance signal are accomplished by an optical receiver module (ORM) 520, 521, and (i) detection of an LOP and (ii) insertion of an OIDLE maintenance signal is done by an optical transmitter module (OTM) 510, 511.

Thus, each ORM has a receiver module 545, a LOP/OAIS/OIDLE detection module 530, an OAIS generator 540, and an OAIS selector 541. Correspondingly, each OTM has a LOP detection module 550, an OIDLE generator 560, an OIDLE selector 561, and a transmitter module 575. The ORM and OTM on the same side of the switch fabric (“SF”) are under the common control of a controller 525.

Bi-directional protection

An LOP failure is always detected by both an ORM 520, 521 and by a OTM 510, 511 in the same direction of transmission. In bi-directional protection an ORM detecting the failure, e.g., 520, inserts an OAIS signal upstream of the failure and the OTM detecting the same failure, e.g., 511, instructs an ORM in the opposite direction, e.g., 521 to insert an OAIS signal. The OTM and the corresponding ORM in the opposite direction of transmission are, in a preferred embodiment, on the same pack to facilitate mutual cross-control. An insertion of an OAIS in the opposite direction does not happen when a detected failure is not protected by the optical network. In a preferred embodiment all nodes downstream from a failure insert an OAIS in the opposite direction. The node that inserts the OAIS and next detects OAIS inserted by the upstream node switches the OAIS selector to the “through” position to let the upstream OAIS through. With reference to FIG. 5, using as an example ORM 520, the OAIS selector having as inputs (a) 590, from LOP/OAIS/OIDLE detection module 520 as well as (b) 592 from the OAIS generator 540, passes input 590 by use of such “through” position. This cyclic control of the OAIS selector transfers an OAIS inserted by the farthest, gateway-out node all the way through to the gateway-in node.

Transfer of the optical network maintenance signal closest to the failure

A transfer of an LOP through the optical network triggers failure detection in all nodes of the optical network downstream from the failure. Nodes detecting an LOP insert an OAIS or an OIDLE maintenance signal according to the node type and the type of service. A detection of the LOP starts the first stage of the failure detection sequence that lasts as long as the provisioned LOP AIS delay. In the second stage each node detects what follows the LOP. If it is an OIDLE or an OAIS signal the node controls its OAIS or OIDLE switch to the “through” position, as illustrated above. This transfers the detected maintenance signal to its output and downstream to the next node.

ORM controller

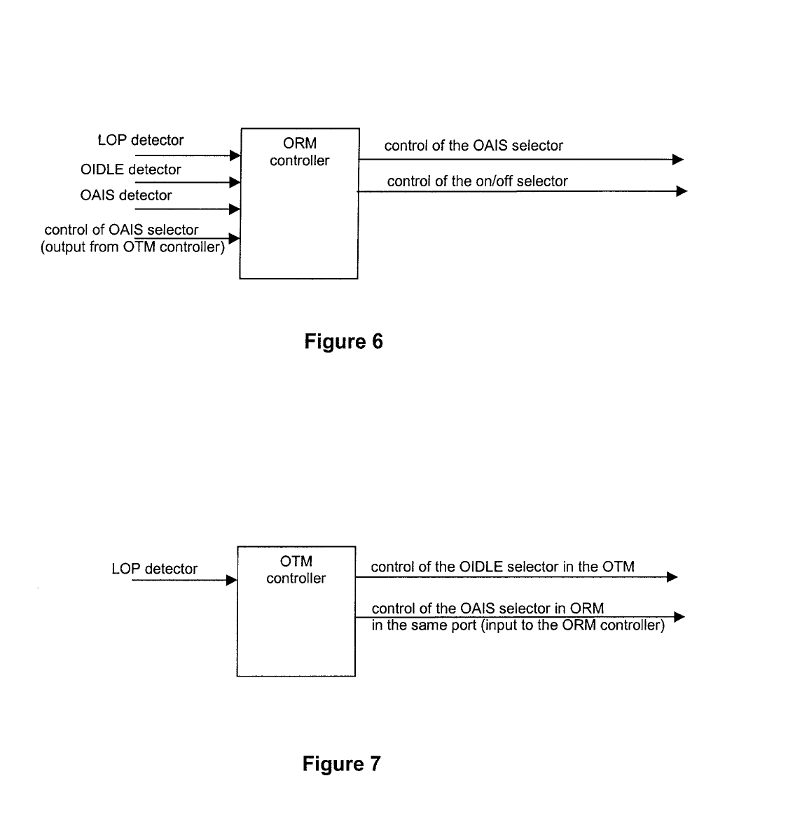

FIG. 6 depicts a block diagram of an exemplary ORM controller. FIG. 7 depicts a similar block diagram of an exemplary OTM controller. As can be seen from these figures, each controller has a given set of inputs and a given set of outputs. The controller implements rules which determine the outputs given the inputs and the type of node in which the controller is operating. In what follows, for ease of viewing the information synoptically, Tables are presented showing the various input and detection sequences for these ORM and OTM controllers.

The failure detection sequences detected by an ORM controller are given in the following Table 1.

TABLE 1
Input failure detection sequences to an ORM controller

| Input sequence: | Detection sequence: |
|---|---|
| OAIS | OAIS-OAIS |
| LOP not cleared | LOP-LOP |
| LOP cleared by incoming outside maintenance | LOP-ais |
| signal | |
| LOP cleared by incoming OAIS (internally | LOP-OAIS |
| generated in optical network) | |
| LOP cleared by incoming OIDLE | LOP-OIDLE-OIDLE |
| LOP cleared by incoming OIDLE cleared by an | LOP-OIDLE-ais |
| outside maintenance signal | |

On/off control of the output power from the ORM by the ORM controller

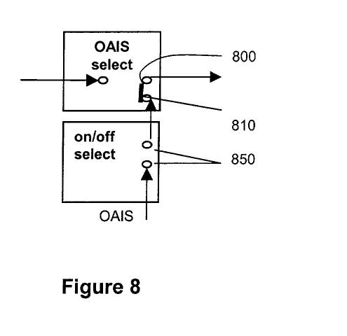

Forcing an LOP condition to the client terminal is achieved by shutting down output power from the ORM. In a preferred embodiment this is done by controlling a 1:1 switch in the arm of an OAIS maintenance signal generator (also depicted in FIG. 5 by index number 540) as shown in FIG. 8.

In this configuration, with reference to FIG. 8, shutting down output power from the ORM requires simultaneous control of the QAIS selector to the “insert OAIS” position 810, thereby connecting the output node 800 to the “insert OAIS” node 810, and of the on/off selector to the “off” position, thereby disconnecting nodes 850 and 851.

Next will be presented an exemplary preferred embodiment of optical maintenance signaling in an all optical network implementing a shared protection scheme. Table 2 lists the various modes of ORM and OTM controllers for nodes of protected and unprotected service lightpaths. These modes are provisioned when provisioning the service lightpath, according to techniques known in the art.

TABLE 2
Modes of the ORM and the OTM controllers

| | Modes of the ORM | Modes of the OTM |
|---|---|---|
| Node_type - Service_type | Controller | Controller |
| Gateway_in - unprotected | ORMM-0 | OTMM-Gin |
| Intermediate - unprotected | ORMM-0 | OTMM-Gin |
| Gateway-out - unprotected | ORMM-Gout | OTMM-0 |
| Gateway_in - protected | ORMM-0 | OTMM-Gin |
| Intermediate - protected | ORMM-ImdP | OTMM-ImdP |
| Gateway_out - protected | ORMM-GoutP | OTMM-GoutP |

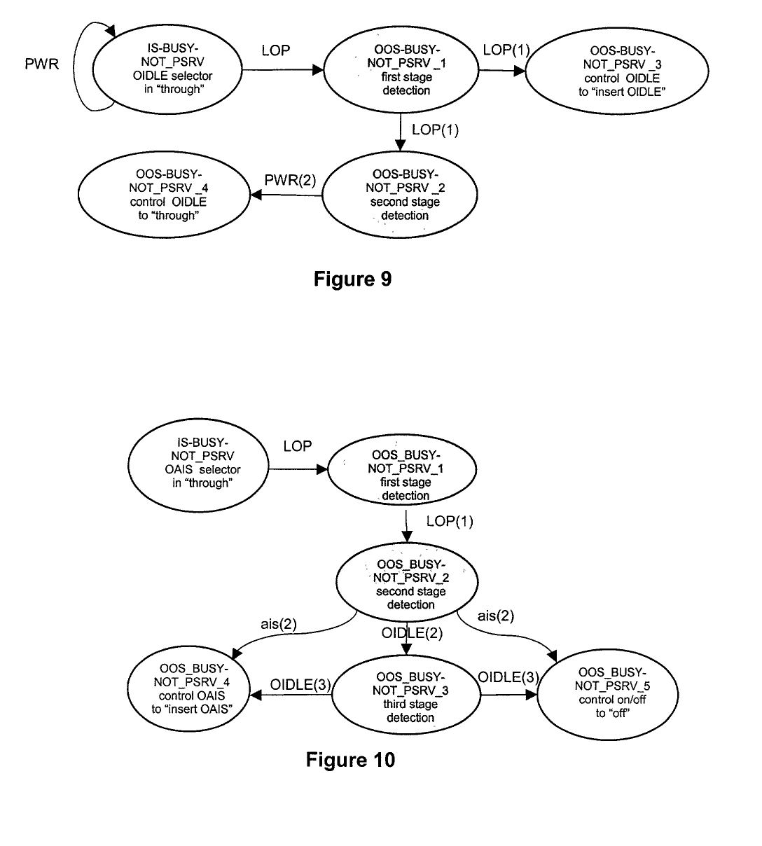

The following discussion defines state transitions associated with these various modes, and the accompanying FIGS. 9-14 depict these state transitions graphically. In FIGS. 9-14 the following exemplary abbreviations for state descriptions are used:

OOS—Out of Service

IS—In service

NOT_PRSV—Not Protected Service

PSERV—Protected Service

Initially the various modes of the ORM and the OTM controllers in the ports of an unprotected service lightpath will be discussed, followed by the protected service lightpath case. It is noted that the upper leftmost state in each of FIGS. 9-14 depicts the normal state, where the node is busy and no LOP or other failure has occurred. In these states the OIDLE and OAIS selectors, as the case may be, are all set to “through”, which passes the input signal through to the output, and no OAIS or OIDLE is inserted. The other states result from some type of failure signal, or a PWR signal being sensed. Stages of detection refer to the same signal, e.g., LOP, being detected at subsequent points in time.

In the following tables, for an ORM mode, the first column indicates the signals seen at the ORM input, and the second column the signals detected by the ORM. The third and fourth columns indicate the control signals applied to the OAIS selector and the on/off selector respectively, as shown in FIG. 8. The final column comments upon the overall action taken.

As well, in the following tables, for an OTM mode, the first column indicates the signals seen at the ORM input, and the second column the signals detected by the OTM. The third and fourth columns indicate the control signals applied to the OIDLE selector and the OIDLE selector in the opposite direction, respectively. The final column comments upon the overall action taken.

### I. ORM and OTM Controller Modes in an Unprotected Service Lightpath

A. Gateway_in Node

1. ORM

TABLE 3
ORMM-0 or “do nothing” mode at the gateway_in
node of an unprotected service lightpath

| failure seen | | Ctrl | | |
|---|---|---|---|---|
| at the ORM | | OAIS | Ctrl on/off | |
| input | ORM detects | selector | selector | Comments |
| LOP-LOP | LOP-LOP | nc | nc | Transfer of LOP |
| LOP-AIS | LOP-ais | nc | nc | Transfer of remote |
| | | | | AIS |
| LOP-OAIS | — | — | — | Not possible |
| Failed ORM | nc | nc | nc | Not detected by |
| | | | | ORM |
| LOP-OIDLE | — | — | — | Not possible |
| PWR-AIS | PWR-PWR | nc | nc | Transfer of remote |
| | | | | AIS |

The entry “nc” in a table refers to no control being implemented. As described above, the default state is for incoming signals to be passed through. The impossible states in Table 3 are due to the fact that at the receiving side of a gateway_in node (such as 395 in FIG. 3) no internally generated maintenance signal (OAIS or OIDLE) can be seen.

B. OTM Controller

TABLE 4
OTMM-Gin mode in the gateway_in node of an unprotected service

| | | | Ctrl OAIS | |
|---|---|---|---|---|
| | | | selector | |
| | | | in the | |
| failure at the | | Ctrl OIDLE | opposite | |
| ORM input | OTM detects | selector | direction | Comments |
| LOP-LOP | LOP-LOP | nc-OIDLE | nc | Inserted OIDLE |
| LOP-AIS | LOP-PWR | nc-OIDLE- | nc | Transfer of |
| | | through | | remote AIS |
| LOP-OAIS | — | — | — | Not possible |
| Failed ORM | LOP-LOP | nc-OIDLE | nc | Detected ORM |
| | | | | failure - inserted |
| | | | | OIDLE |
| LOP-OIDLE | — | — | — | Not possible |
| PWR-AIS | PWR-PWR | Nc | nc | No detection - |
| | | | | transfer of remote |
| | | | | AIS |

FIG. 9 depicts a state transition diagram for the OTMM-Gin (for “OTM Mode Gateway_in”; similar state names for remaining nodal modes) control modes defined by Table 4. It is noted that since the node is a gateway_in, OAIS and OIDLE cannot be seen at the ORM input. Remote AIS is passed through, and an incoming LOP, as well as an ORM failure, generate an inserted OIDLE.

B. Intermediate node

1. ORM Controller

TABLE 5
ORMM-0 “do nothing” mode in an intermediate node
of an unprotected service

| failure at the | | Ctrl OAIS | Ctrl on/off | |
|---|---|---|---|---|
| ORM input | ORM detects | selector | selector | Comments |
| LOP-LOP | LOP-LOP | nc | nc | Transfer of |
| | | | | LOP |
| LOP-AIS | LOP-ais | nc | nc | Forced LOP |
| | | | | to OTM |
| LOP-OAIS | — | — | — | Not possible |
| Failed ORM | nc | nc | nc | Not detected |
| | | | | by ORM |
| LOP-OIDLE- | LOP-OIDLE- | nc | nc | Transfer of |
| OIDLE | OIDLE | | | OIDLE |
| LOP-OIDLE- | LOP-OIDLE-ais | nc | nc | Transfer of |
| AIS | | | | remote AIS |

2. OTM Controller

TABLE 6
OTMM-Gin mode in the intermediate node of an unprotected service

| | | | Ctrl OAIS | |
|---|---|---|---|---|
| | | | selector | |
| | | control | in the | |
| failure at the | | OIDLE | opposite | |
| ORM input | OTM detects | selector | direction | Comments |
| LOP-LOP | LOP-LOP | nc-OIDLE | nc | Inserted |
| | | | | OIDLE |
| LOP-AIS | LOP-LOP | nc-OIDLE | nc | Inserted |
| | | | | OIDLE |
| LOP-OAIS | — | — | — | Not possible |
| Failed ORM | LOP-LOP | nc-OIDLE | nc | OTM detects |
| | | | | failure and |
| | | | | inserts OIDLE |
| LOP-OIDLE- | LOP-PWR- | nc-OIDLE- | nc | Transfer of |
| OIDLE | PWR | through | | remote OIDLE |
| LOP-OIDLE- | LOP-PWR- | nc-OIDLE- | nc | Transfer of |
| AIS | PWR | through | | remote |
| | | | | AIS |

C. Gateway_out node

1. ORM Controller

TABLE 7
ORMM-Gout mode in the gateway_out node of an unprotected service

| Failure at the | | Ctrl OAIS | Ctrl on/off | |
|---|---|---|---|---|
| ORM input | ORM detects | selector | selector | Comments |
| LOP-LOP-LOP | LOP-LOP- | nc | nc | Transfer of |
| | LOP | | | LOP |
| LOP-AIS-AIS | LOP-ais- | nc-nc- | nc-nc-OFF | Forced LOP to |
| | ais | OAIS | | OTM |
| LOP-OAIS-OAIS | — | — | — | Not possible |
| Failed ORM | nc | Nc | nc | not detected by |
| | | | | ORM |
| LOP-OIDLE- | LOP- | nc-nc-nc- | nc-nc-nc- | Forced LOP to |
| OIDLE | OIDLE- | OAIS | OFF | OTM |
| | OIDLE | | | |
| LOP-OIDLE-AIS | LOP- | nc | nc | Transfer of |
| | OIDLE-ais | | | remote AIS |

FIG. 10 depicts a state transition diagram of the ORMM-Gout control mode defined by Table 7.

2. ORM Controller

TABLE 8
OTMM-0 “do nothing” mode in the gateway_out node
of an unprotected service

| | | | Ctrl OAIS | |
|---|---|---|---|---|
| failure | | Ctrl | selector in | |
| at the | | OIDLE | the opposite | |
| ORM input | OTM detects | selector | direction | Comments |
| LOP-LOP- | LOP-LOP-LOP | nc | nc | Transfer of |
| LOP | | | | LOP to client |
| LOP-AIS- | LOP-PWR- | nc | nc | Transfer of |
| AIS | LOP | | | LOP to client |
| LOP-OAIS- | — | — | — | not possible |
| OAIS | | | | |
| Failed ORM | LOP-LOP-LOP | nc | nc | Transfer of |
| | | | | LOP to client |
| LOP-OIDLE- | LOP-PWR- | nc | nc | Transfer of |
| OIDLE | PWR-LOP | | | LOP to client |
| LOP-OIDLE- | LOP-PWR- | nc | nc | Transfer of |
| AIS | PWR | | | remote AIS to |
| | | | | client |

### II. ORM AND OTM Controller Modes in a Protected Service Lightpath

The following sections define modes of the ORM and the OTM controllers in the ports of a protected service lightpath.

A. Gateway_in node

The ORM mode in the gateway_in node of a protected service is the ORMM-0 “do nothing” mode. The OTM mode in the gateway_in node of a protected service is the OTMM-Gin mode.

B. Intermediate node

TABLE 9
ORMM-ImdP mode in an intermediate node of a protected service

| Failure | | Ctrl | Ctrl | |
|---|---|---|---|---|
| at the | ORM | OAIS | on/off | |
| ORM input | detects | selector | selector | Comments |
| LOP-LOP | LOP-LOP | nc-OAIS | nc | Insertion of OAIS |
| | | | | after LOP |
| LOP-AIS | LOP-ais | nc-OAIS | nc | Shut-down power |
| | | | | (no OAIS |
| | | | | insertion) |
| LOP-OAIS | LOP-OAIS | nc-OAIS- | nc | Transfer of |
| | | through | | OAIS |
| Failed ORM | nc | nc | nc | not detected by |
| | | | | ORM |
| LOP-OIDLE- | LOP-OIDLE- | nc-OAIS- | nc | Transfer of |
| OIDLE | OIDLE | through | | remote OIDLE |
| LOP-OIDLE- | LOP-OIDLE- | nc-OAIS- | nc | Transfer of |
| AIS | ais | through | | remote AIS |
| OAIS-OAIS | OAIS-OAIS | nc-through | nc | Transfer of |
| | | | | remote AIS |

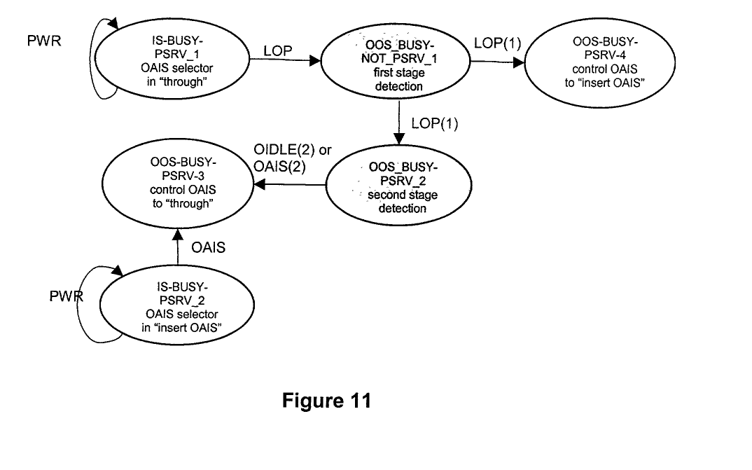

FIG. 11 depicts a state transition diagram for the OTMM-ImdP mode defined by Table 9.

TABLE 10
OTMM-ImdP mode in an intermediate node of a protected service

| | | | Ctrl OAIS | |
|---|---|---|---|---|
| | | control | selector in | |
| failure at the | | OIDLE | the opposite | |
| ORM input | OTM detects | selector | direction | Comments |
| LOP-LOP | LOP-LOP- | nc | nc-OAIS | Shut-down opp. |
| | PWR | | | dir, inserted |
| | | | | OAIS |
| LOP-AIS | LOP-PWR- | nc | nc-OAIS | Shut-down opp. |
| | PWR | | | dir, inserted LOP |
| LOP-OAIS | LOP-PWR- | nc | nc-OAIS | Transfer of OAIS |
| | PWR | | | |
| Failed ORM | LOP-LOP- | nc | nc-OAIS | Shut-down opp. |
| | LOP | | | dir, inserted LOP |
| LOP-OIDLE- | LOP-PWR- | nc | nc-OAIS | Transfer |
| OIDLE | PWR | | | |
| LOP-OIDLE- | LOP-PWR- | nc | nc-OAIS | Transfer |
| AIS | PWR | | | |
| OAIS-OAIS | PWR-PWR | nc | nc | Transfer of OAIS |

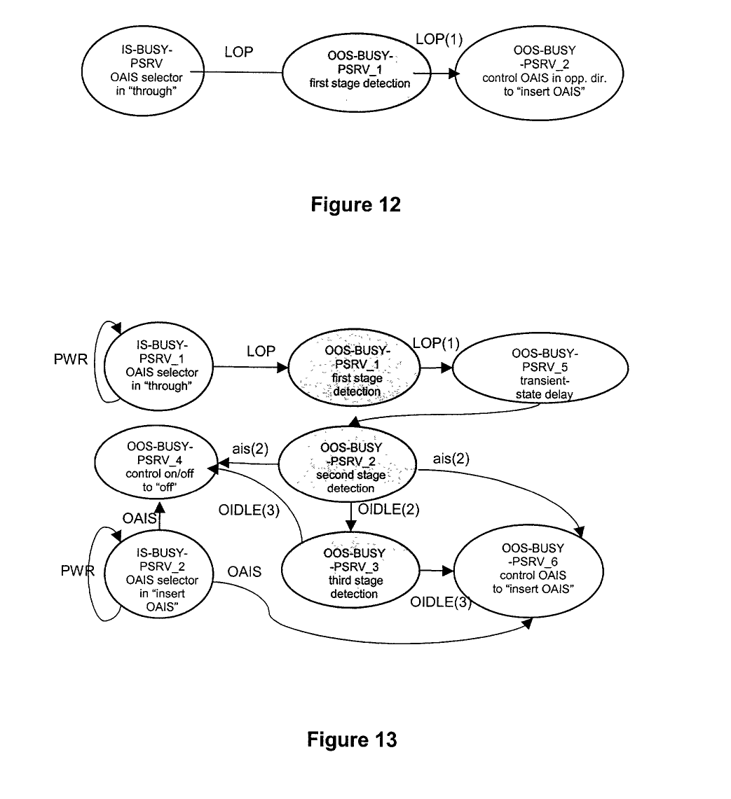

FIG. 12 depicts a state transition diagram for the OTMM-ImdP mode defined by Table 10.

C. Gateway_out node

TABLE 11
ORMM-GoutP mode in the gateway_out node of a protected service

| failure at | | Ctrl | | |
|---|---|---|---|---|
| the ORM | | OAIS | Ctrl on/off | |
| input | ORM detects | selector | selector | Comments |
| LOP-LOP | LOP-LOP-LOP | nc | nc | transfer |
| LOP-AIS | LOP-ais-ais | nc-nc- | nc-nc-OFF | Shut-down |
| | | OAIS | | power |
| LOP-OAIS | LOP-OAIS- | nc-nc- | nc-nc-OFF | Shut-down |
| | OAIS | OAIS | | power (logic |
| | | | | only) |
| Failed ORM | nc | nc | nc | not detected by |
| | | | | ORM |
| LOP-OIDLE- | LOP-OIDLE- | nc-nc- | nc-nc-nc- | Shut-down |
| OIDLE | OIDLE | nc-OAIS | OFF | power to client |
| LOP-OIDLE- | LOP-OIDLE- | nc | nc | Transfer of |
| AIS | PWR | | | remote AIS |
| OAIS-OAIS | OAIS-OAIS | nc-OAIS | nc-OFF- | Transfer of |
| | | | ON | remote AIS |

Transmission delay delays transfer of the OAIS/OIDLE to the gateway-out node. In the transient-state the gateway-out node could detect a maintenance signal that is not closest to the failure. To avoid that a fixed delay is inserted in the gateway-out node, called a transient-state delay. FIG. 13 shows a state transition diagram of the ORMM-GoutP mode defined by Table 11.

TABLE 12
OTMM-GoutP mode in the gateway_out node of a protected service

| | | | Ctrl | |
|---|---|---|---|---|
| | | | OAIS | |
| | | | selector | |
| failure at | | Ctrl | in the | |
| the ORM | OTM | OIDLE | opposite | |
| input | detects | selector | direction | Comments |
| LOP-LOP- | LOP-LOP- | nc-OIDLE- | nc-nc-nc- | forced |
| LOP | LOP | nc | OAIS | failure in |
| | | | | op. dir. |
| | | | | masked roll |
| LOP-AIS- | LOP-PWR- | nc-OIDLE- | nc-nc-nc- | forced |
| AIS | LOP | nc | OAIS | failure in |
| | | | | op. dir. |
| | | | | masked roll |
| LOP-OAIS- | LOP-PWR- | nc-OIDLE- | Nc | Masked |
| OAIS | LOP | nc | | roll - has |
| | | | | to shut- |
| | | | | down ORM |
| | | | | to not |
| | | | | remove it |
| Failed ORM | LOP-LOP- | nc-OIDLE- | nc-nc-nc- | Detected |
| | LOP | nc | OAIS | failure of |
| | | | | ORM, forced |
| | | | | failure |
| | | | | in op. dir. |
| | | | | masked roll |
| LOP-OIDLE- | LOP-PWR- | nc-OIDLE- | Nc | Transfer of |
| OIDLE | PWR-LOP | nc-nc- | | LOP to |
| | | through | | client |
| LOP-OIDLE- | LOP-PWR- | nc-OIDLE- | Nc | Transfer of |
| AIS | PWR-PWR | nc-nc- | | remote AIS |
| | | through | | to client |
| OAIS-OAIS | PWR-LOP- | nc-OIDLE | Nc | Transfer of |
| | PWR | | | remote AIS |
| | | | | to client |

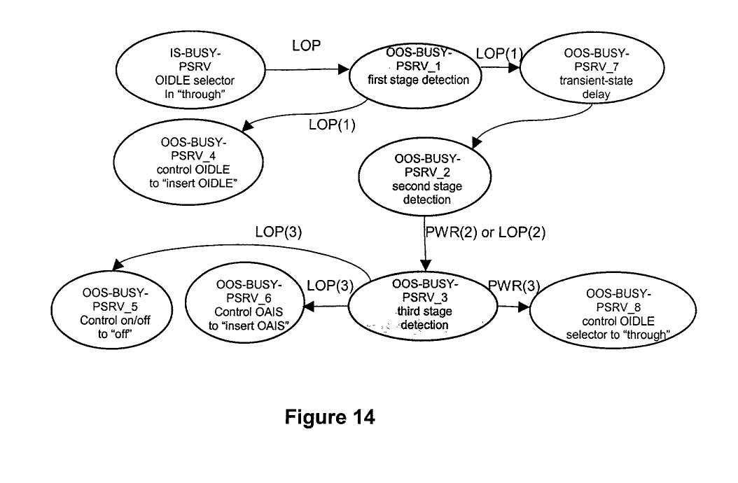

FIG. 14 shows a state transition diagram for the OTMM-GoutP mode defined by Table 12.

ORM and OTM modes in the region-boundary node

The ORM mode in the region-boundary node (see FIG. 3, Index No. 375) of a protected service is the ORMM-GoutP mode. The OTM mode in the region-boundary node of a protected service is the OTMM-GoutP mode.

While the above describes the preferred embodiments of the invention, various modifications or additions will be apparent to those of skill in the art. Such modifications and additions are intended to be covered by the following claims.

What is claimed:

1. A method of implementing maintenance signaling in an optical data network, comprising the use of a finite set of optical symbols to distinguish between different classes of failures.

2. The method of claim 1, where faults which are protected within the network are distinguished from faults originating outside the network by the use of different optical signals.

3. The method of claim 2, used in unidirectional and bi-directional local mesh region-by-region protection.

4. The method of claim 2, used in unidirectional and bi-directional end-to-end protection.

5. The method of any of claims 1-4, where the network implements shared protection.

6. The method of claim 1, where the following types of optical maintenance signaling are implemented:
a loss of power (LOP) failure and corresponding maintenance signaling generated outside the boundaries of the optical network is transparently transferred through the network;
a LOP failure and corresponding maintenance signaling generated by the DWDM transmission systems inside an optical network protecting the failure is suppressed by the network; and
a LOP failure and corresponding maintenance signaling by the DWDM transmission systems inside boundaries of an optical network not protecting the failure is transferred as the LOP to the client terminal.

7. Apparatus for optical maintenance signaling, comprising:
a signal generator, capable of generating at least two distinguishable optical symbols; and
one or more controllers, arranged to distinguish various failure types and cause the optical symbols to be generated in response thereto.

8. A method of implementing shared protection in an optical data network, comprising:
subdividing the network into distinct regions;
where within each region resources are available to provide protection for all paths within the region.

9. The method of claim 8, where the subdivision is accomplished by the introduction of gateway nodes, which communicate failures so as to distinguish between faults originating outside the network and faults protected by the network.

10. The method of claim 9, where said failures are communicated by means of different optical symbols.

11. The method of claim 10, where said optical symbols are bit rate and format independent.

12. A method of using time to communicate information between network elements that are not interoperable, comprising;
defining a delay;
a first network element sending a first signal;
the first network element sending a second signal after the defined delay, said signal distinguishable from the first by a second network element.

13. The method of claim 12, where the first signal is a data signal, and the second an alarm signal in response to a detected failure.

14. The method of claim 13, where the second network element can distinguish between the second signal, and a power glitch by means of the defined delay.
